(19) United States
(12) Patent Application Publication
(10) Pub. No.: US 2017/0129040 A1
(43) Pub. Date: May 11, 2017

(54) METHOD FOR PRODUCING A CHASSIS COMPONENT

(71) Applicant: ZF Friedrichshafen AG, Friedrichshafen (DE)

(72) Inventors: Wolfgang EULERICH, Osnabrück (DE); Andreas WELZEL, Belm (DE); Guido KOHLBRECHER, Wallenhorst (DE)

(21) Appl. No.: 15/318,793

(22) PCT Filed: May 19, 2015
(86) PCT No.: PCT/EP2015/060945

§ 371 Date: Dec. 14, 2016

(30) Foreign Application Priority Data
Jun. 23, 2014 (DE) 102014211924.3
Apr. 21, 2015 (DE) 10 2015 207 176.6

(51) Int. Cl. B23K 11/00; B62D 27/02; B23K 11/093; B62D 65/02

(52) U.S. Cl. CPC B23K 11/002; B62D 65/02; B62D 27/023; B23K 11/093; B23K 2201/006

(57) ABSTRACT

A method of producing a chassis component which includes a housing that is connected to a structural component by a weld. A receiving opening is formed in the structural component and the housing is pushed into the receiving opening, where a surface on the housing and a surface on the structural component are in contact with one another. At least one of the two surfaces in contact is formed as an oblique surface relative to the other of the two surfaces so that, before welding, a line contact exists between the two surfaces. Alternatively, the receiving opening in the structural component can be made slightly undersize relative to the housing geometry that is pushed into the receiving opening.

This application is a National Stage completion of PCT/EP2015/060945 filed May 19, 2015, which claims priority from German patent application serial nos. 10 2014 211 924.3 and 10 2015 207 176.6 filed Jun. 23, 2014 and Apr. 21, 2015 respectively.

### FIELD OF THE INVENTION

The invention concerns a method for producing a chassis component.

### BACKGROUND OF THE INVENTION

Chassis components of the type concerned are known in many different designs. As a rule they comprise a structural component and one or more housings connected solidly thereto, in particular ball joint housings. For example, such a chassis component is a chassis linkage wherein the housing, in particular the ball joint housing, is as a rule integrated into the structural component by injection molding, press-fitting, screwing, riveting or welding.

From DE 203 11 595 U1 a ball joint with a housing in the form of a ball joint housing is known, which has a weld zone by means of which it can be welded to a structural component in the form of a chassis linkage, the housing being set into a receiving opening of the structural component and the weld zone of the housing being welded to the structural component. In one design the weld zone is chamfered on one side, namely the side intended to rest in contact with the rim of the receiving opening in the structural component.

From DE 10 2010 043 040 A1 a method is known for the production of a chassis component, in which before being welded to one another two housing components, a structural component and a housing in the form of a ball joint housing, can be coated individually. Laser welding is recommended as the preferred welding method. It has been found, however, that the connection by welding on the one hand demands very precisely produced components, and because of the coating present qualitative disadvantages can occur in the weld joint. Accordingly the coating is removed in the area of the weld joint and because of that a production drawback has to be accepted. Furthermore, owing to the removal of the coating corrosion problems can occur in the annular gap between the two components.

### SUMMARY OF THE INVENTION

The purpose of the present invention is to minimize the problems known from the prior art.

According to the invention, this objective is achieved by forming at least one of the two surfaces in contact, in relation to the other of the two surfaces, as an oblique surface so that before welding a line contact is formed between the two surfaces.

Welding is carried out by resistance welding, in particular condenser discharge welding or medium-frequency welding. The linear contact centers the two components and results in partial melting and hence in a material-merged connection without any added weld filler. In particular, the line contact extends all round the circumference.

A further invention provides that relative to the geometry of the housing which is pushed into the receiving opening, the receiving opening in the structural component is made slightly undersize. Thanks to this press-fitted joint, during welding a large weld area is produced in the area of the outer surfaces, which can transmit large forces.

Basically, the geometry of the housing can have a constant cross-section or a tapering cross-section. In the case of a tapering cross-section a self-centering effect can be used during assembly. Thanks to the self-centering between the housing and the receiving opening, manufacturing tolerance deviations between the joint partners, namely the structural component and the housing, can be compensated. In this way an all-round line contact can be produced reliably. The all-round line contact is important in order, during the subsequent welding, to achieve uniform welding conditions and in particular a uniform welding current density around the whole circumference in the area of the line contact. This in turn is important for the achievement of a reproducible and uniform welding process as is necessary for mass production.

In the context of the invention a structural component is understood to be an areal metallic sheet component, which can be curved or flat or partially curved and partially flat. Areal means that the thickness of the material of the structural component is very much smaller than its other dimensions. The material thickness is preferably constant over the areal extension of the structural component, which in particular is a solid structure. In the context of the invention a receiving opening is a cut-out aperture, whether round or not round, which passes right through the structural component. Preferably, the receiving opening is surrounded by the structural component all the way round.

According to an advantageous subordinate claim the opening, specifically the receiving opening, is produced in the structural component by a stamping process. Stamping can produce high dimensional accuracy with comparatively simple tools.

Furthermore, it can be provided that in the opening, specifically the receiving opening, a recession is formed which extends obliquely relative to the central axis of the opening. In a longitudinal section through the central axis of the opening the recession looks like a chamfer on each side of the central axis. This recession can serve to center the two components before welding, or receive melted material.

Advantageously, the oblique surface facing toward the structural component is formed on the housing. Independently of this oblique surface the housing needs a number of working steps during which the oblique surface can be formed as well.

The housing has a step which acts as an interlocking supporting connection if the weld is at risk of fracturing. The oblique surface on the housing side is formed on this step. The step also has the advantage that a pressing tool can be fitted over it so that the housing geometry will not be subjected to the pressing force. Furthermore, an annular gap in the contact area between the step and the structural component is closed by the weld.

Advantageously, the connection of the receiving opening, formed as a through-going opening, with the housing is made with some clearance, so that an annular gap is present. The clearance fit allows greater manufacturing tolerance.

To avoid crevice corrosion the annular gap between the housing and the through-going opening is closed by the displacement of volume fractions of the housing and/or of the structural component. The annular gap can be closed very easily by axially upsetting a rim of the through-going opening.

Alternatively, the annular gap between the housing and the through-going opening can be closed by a coating applied to the entire welded assembly, so that corrosion protection is thereby achieved.

According to an alternative design, outer surfaces of the receiving opening and the housing, each extending parallel to the central axis if the receiving opening and the housing, are welded to one another. In this embodiment the receiving opening in the structural component is at least of substantially cylindrical shape. The receiving opening can on the other hand be divided into a smooth section and stamping break-out area. In turn, the housing has an oblique centering area facing toward the receiving opening. Relative to the geometry of the housing that is pushed into the receiving opening, the receiving opening in the structural component is made slightly undersize. Immediately before welding, there is again a line contact between the two joint partners. In particular, the structural component is orientated in such manner that the smooth section of the receiving opening faces toward the oblique centering surface. After welding begins, in the axial direction the centering surface is covered first. The centering bevel is followed, on the largest diameter in the axial extension of the housing, by an area which has on its outside a cylindrical surface.

Thereafter, the joint partners are moved relative to one another farther in the axial joint direction to form a weld of rectangular shape when seen in cross-section, with two at least essentially parallel sides extending in the direction of the central axes of the receiving opening and the housing. The rectangular weld, with sides that extend parallel to the central axis of the structural component and the housing, extends through the full material thickness of the structural component, or part thereof. In the latter case the structural component and the housing are separated from one another through the remainder of the material thickness, so that an annular gap is again formed. The annular gap between the housing and the through-going opening can again be closed by displacing volume fractions of the housing and/or of the structural component in order to avoid crevice corrosion. Alternatively, the annular gap between the housing and the through-going opening can again be closed by coating the entire welded assembly, and so can be protected against corrosion. During the subsequent assembly process the annular gap is covered by the sealing bellows and so likewise protected against corrosion, in particular crevice corrosion. After the end of the welding process, the structural component is fixed to the housing in such manner that its underside is a distance away from the second oblique surface. The underside and the second oblique surface are preferably positioned at an angle of 45° to one another. The second oblique surface is formed on the step. This arrangement avoids the risk of crevice corrosion at that point. This area can be given a surface coating after welding without problems, for example by spraying, immersion or electroplating. The second oblique surface is formed on the step.

In all the designs described so far the joint partners, namely the structural component and the housing, are moved relative to one another exclusively in translation during welding.

The invention also relates to a chassis component comprising a structural component and a housing, in particular one in the form of a ball joint housing, which chassis assembly is produced in accordance with a method as described above. The invention proposes that the chassis component is in the form of a flange joint or a multi-point link. In the context of the invention a flange joint is understood to be a chassis component consisting of a ball joint and a connecting flange, the connecting flange serving to connect the flange joint to another chassis component such as a link component. A multi-point link in the context of the invention is a chassis link with more than one and fewer than five link points, at least one of the link points comprising a ball joint. Referring to the number of link points, these chassis links are also known as two-point, three-point or four-point links.

When the ball joint housing has been inserted into the receiving opening in the structural component and the structural component and the ball joint housing have then been welded together, no further welding operations on the chassis assembly in the form of a flange joint or a multi-point link are needed. Thus, the chassis component has the advantage that it can be provided with corrosion protection all over its surface, which protection remains in place during any further finishing work. Effective corrosion protection is especially important for flange joints and multi-point links because, on account of the position where they are fitted in the vehicle, these are particularly exposed to environmental influences that favor corrosion, such as moisture and road salt.

Advantageously, the housing in the form of a ball joint housing is part of a radial ball joint, an axial ball joint or a ball sleeve joint. Ball joint housings of the type described earlier can be made as the housing or part of the housing of radial ball joints, axial ball joints or ball sleeve joints. A ball joint housing already connected to a structural component by a material-merging method such as welding without a filler, which is assembled further to produce a complete ball joint, has the advantage that components of the ball joint inside the ball joint housing can no longer be damaged by the heat produced during welding.

### BRIEF DESCRIPTION OF THE DRAWINGS

With reference to the figure descriptions given below, the invention is explained in more detail. In the figures, the same indexes denote the same or functionally equivalent components or elements.

FIG. 1: Illustration of the chassis component

FIGS. 2-4: Connection between the housing and the structural component, with an annular gap

FIGS. 5-7: Connection between the housing and the structural component, with an undersize fit and an oblique surface

FIGS. 8-9: Connection between the housing and the structural component, with a plurality of oblique surfaces

FIGS. 10-12: Connection between the housing and the structural component, with an undersize fit and parallel outer surfaces of the structural component and the housing.

### DETAILED DESCRIPTION OF THE PREFERRED EMBODIMENTS

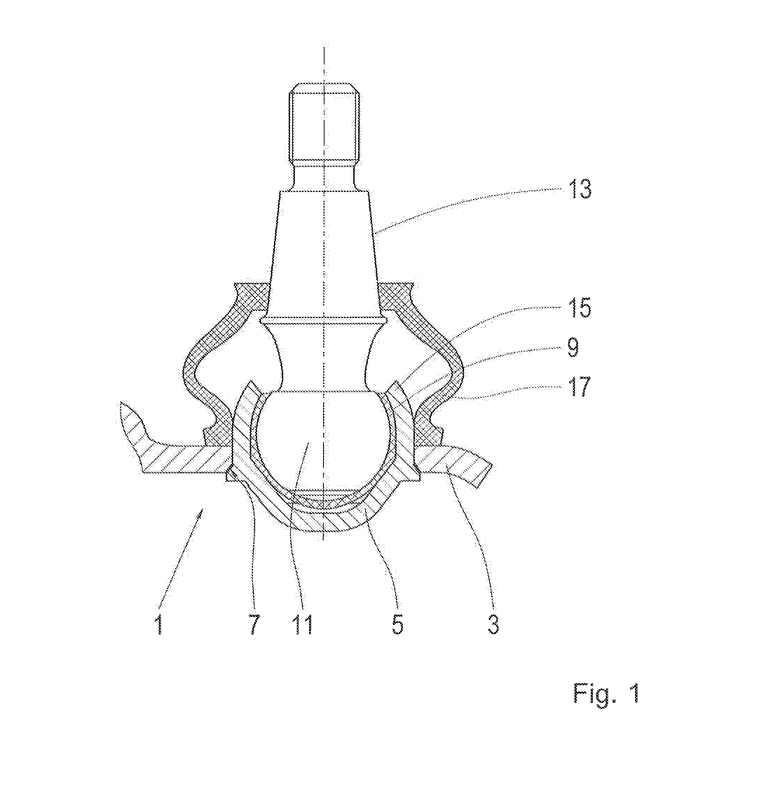

FIG. 1 shows a chassis component 1 with a ball joint. A structural component 3, which serves for example to form a connection to some other component in a chassis, is connected to a housing 5 by means of a weld 7. The weld 7 is produced by resistance welding with no filler. Inside the housing 5 is arranged a ball socket 9, into which a joint ball 11 of a ball pin 13 is fitted so that it can rotate and swivel. The ball socket 9 extends beyond the equator of the joint ball 11 and is secured by a radially inward shaped rim 15 of the housing 5. A sealing bellows 17 protects the ball joint against dirt and/or moisture from the outside.

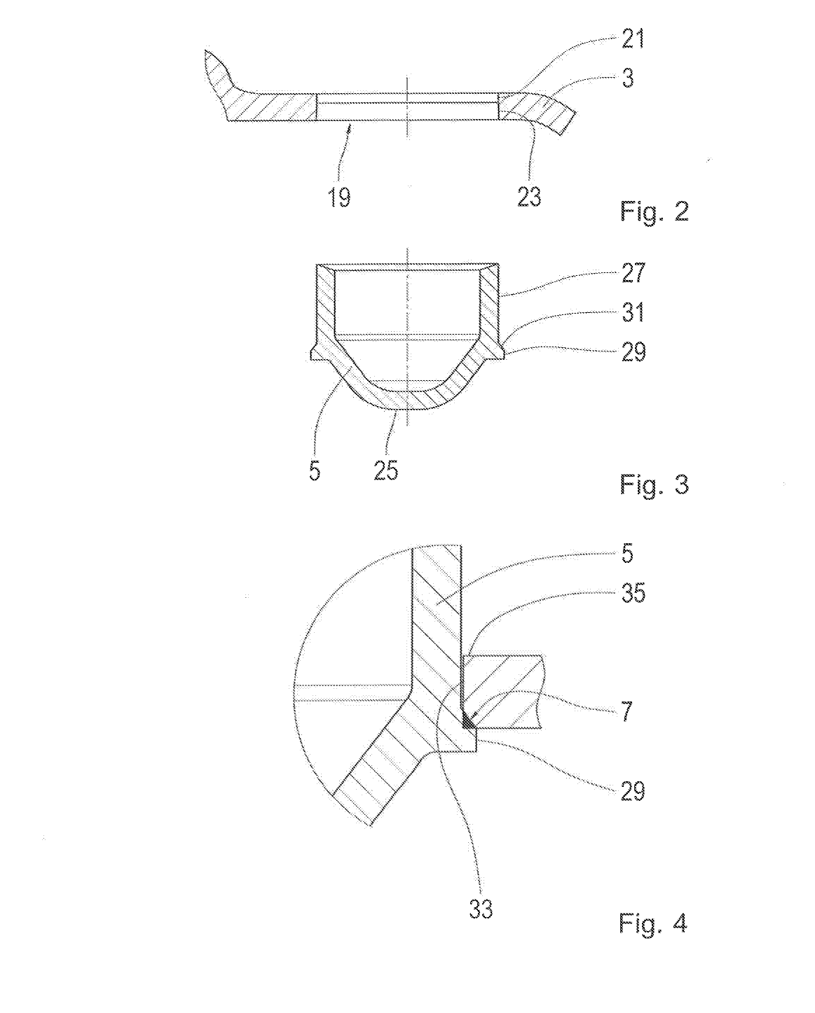

The sequence of FIGS. 2 to 4 makes clear the structure and the production method of the housing 3; 5 as a whole. In the structural component 3 a receiving opening 19 is produced by stamping. In this, a smooth section 21 of the stamped surface can be adjacent to an upper or a lower side of the structural component. A stamping break-out surface 23 can have a slightly conical shape comparable with a conical recess. Furthermore, the rim 35 of the receiving opening 19 can have a recession 41 in the form of a chamfer, an oblique surface or a rounded surface, which extends obliquely relative to the central axis of the receiving opening 19.

The housing is closed at the bottom and in that area has a spherically curved base area 25, which merges into an annular wall 27 that extends in the axial direction. In this example component the annular wall 27, which forms the geometry of the housing, has a constant cross-section.

At the transition between the base area 25 and the annular wall 27 a step 29 with an oblique surface 31 facing toward the structural component 3 is formed. The outer diameter of the step 29 is larger than the receiving opening 19 in the structural component 3, and in turn the receiving opening 19 is larger than the outer diameter of the annular wall 27 which, incidentally or alternatively to the oblique surface 31 of the step, can also be shaped conically and therefore with an oblique surface.

To assemble the structural component 3 with the housing 5, the housing 5 with its annular wall 27 is pushed into the receiving opening 19 until the structural component is in contact with the oblique surface 31 of the housing 5. In the case illustrated, between the housing 5 and the receiving opening made as a through-going opening 19 there is a clearance fit with an annular gap 33. Thereafter, welding electrodes (not shown) are placed axially on the housing 5 and on the structural component 3 under some axial pressure. For this the underside of the step 29 can be used to good advantage, since the welding electrode can be positioned very close to a weld 7 to be produced. In the contact zone of the oblique surface 31 against the wall of the through-going opening 19, the material is melted and the weld 7 is produced.

In a further work step the annular gap 33 is closed. Either a coating is used, which penetrates into the annular gap 33, or volume fractions of the housing 5, for example of the annular wall 27, and/or of the structural component, are displaced. In a particularly simple manner which also preserves the geometry of the housing, the rim 35 of the through-going opening 19 can be axially compressed so that material is pushed radially inward and seals the annular gap 33 reliably.

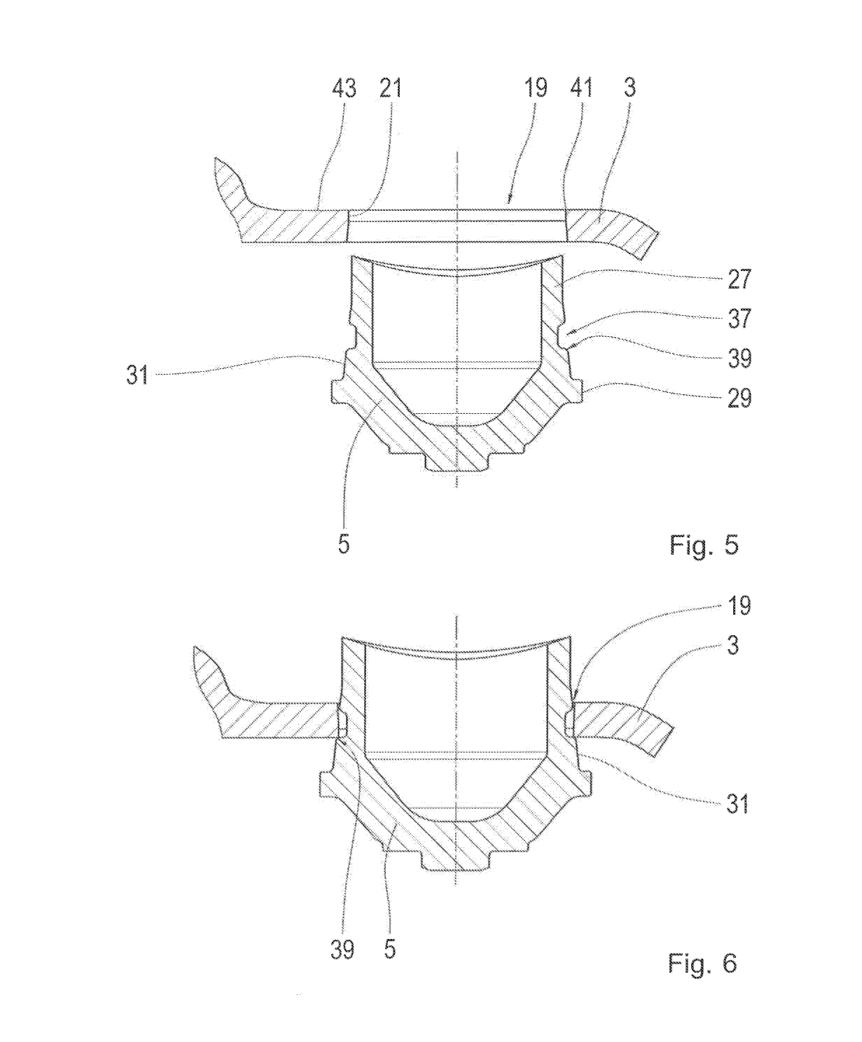

FIGS. 5 to 7 show a deviation from the production method described in relation to FIGS. 2 to 4. The difference is that relative to the geometry of the housing, i.e. to the outer diameter of the annular wall 27 which is pushed into the receiving opening 19, the receiving opening 19 is made slightly undersized.

Below an annular groove 37 provided for holding the sealing bellows 17, a centering bevel 39 is formed on the outer shell surface of the annular wall 27. The length area between the centering bevel 39 and the step 29 is in the shape of a cone with an oblique surface 31 relative to the receiving opening 19. Alternatively, the receiving opening 19 too can be stamped conically and the area between the centering bevel 39 and the step 29 can be made with a constant outer diameter. In the simplest version the length area can also have a constant cross-section and the receiving opening a constant diameter. The orientation of the smooth section 21 in the receiving opening 19 can be chosen as desired. An advantageous trend is for the smooth section 21 to face upward as in FIG. 5 and for there to be a chamfer 41 of the recession at the transition from the receiving opening 19 to the upper side 43. In this variant the sometimes burr-forming transition from the stamping fracture 23 to the underside 45 of the structural component 3 is melted during welding. If the smooth section 21 faces downward, this has the advantage that there is particularly good line contact between the structural component 3 and the housing 5.

FIG. 6 shows the assembly situation when the housing 5 is inserted into the receiving opening 19 and the structural component 3 is resting against the centering bevel 39. This secures the radial position of the structural component 3 relative to the housing 5. In a further production stage an axial preload is exerted by means of welding electrodes (not shown) on the two components 3; 5.

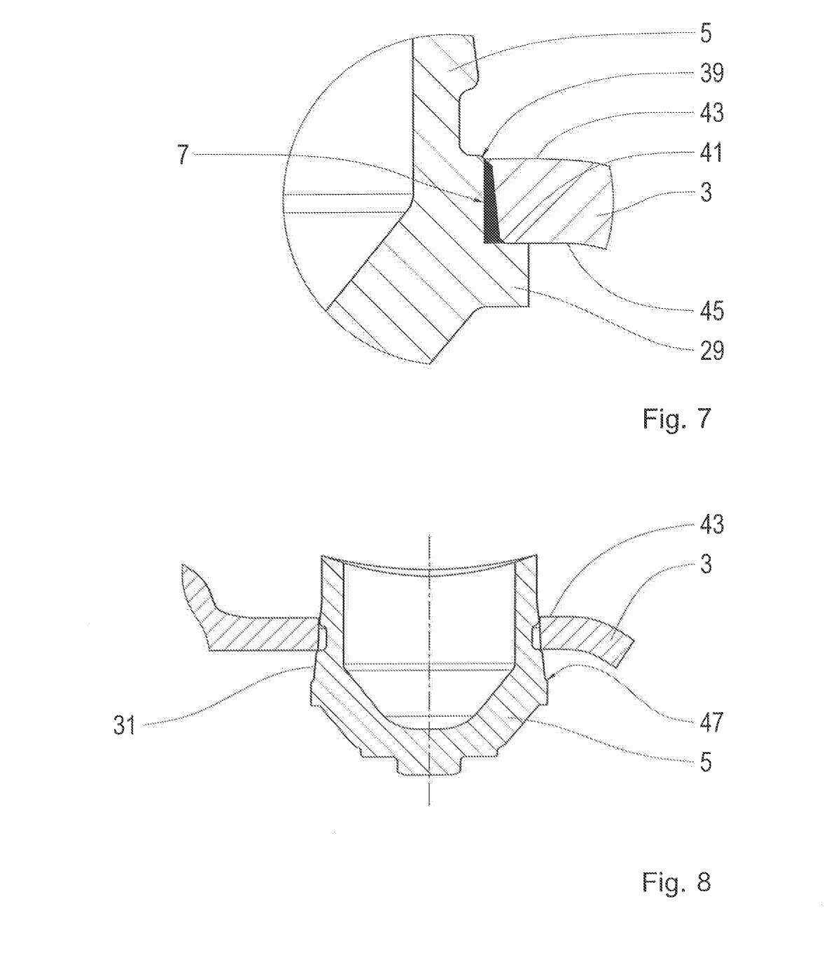

FIG. 7 shows the housing 5 and the structural component 3 with the weld 7. The weld 7 extends over the full axial length of the through-going opening 19. In FIG. 7 the chamfer 41 on the through-going opening 19 is made on the underside 45. If, as described above, the chamfer 41 is made on the upper side 43, then the area is also filled with displaced melted material.

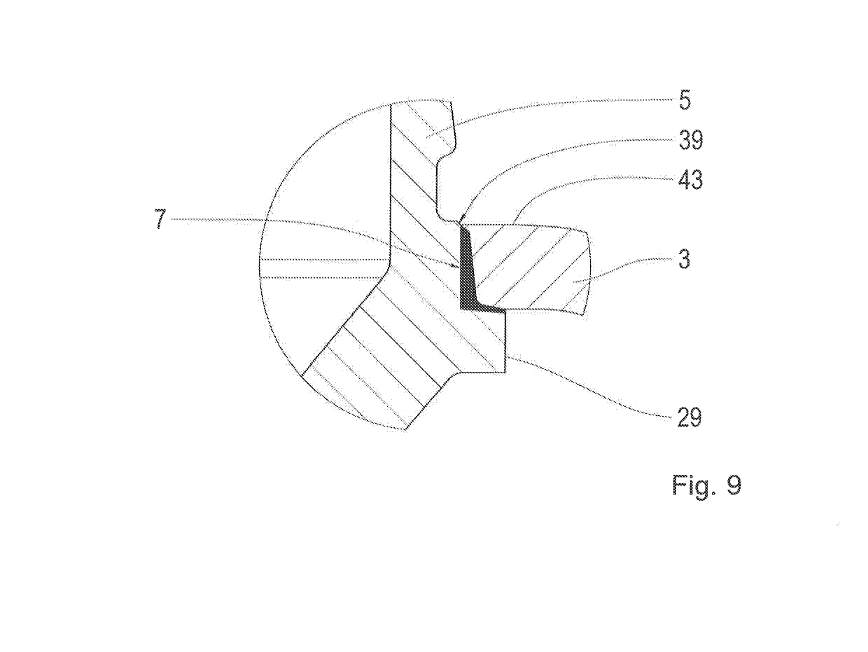

FIGS. 8 and 9 show a variant in which features of the configuration in the variant according to FIGS. 2 to 4 are combined with features of the variant according to FIGS. 5 to 7.

Thus, on the housing 5 is formed an oblique surface 31 facing toward the structural component 3, and the diameter of the receiving opening 19 is slightly undersized relative to this oblique surface 31. Furthermore, the step is made with a further oblique surface 47 relative to the structural component 3. The assembly sequence corresponds to the description concerning FIGS. 2 to 7, but with the difference that the weld zone is radially longer, extending as far as the outer diameter of the step 29. Consequently, the gap between the structural component 3 and the housing 5 is completely closed. Basically, compared with the design according to FIGS. 2 to 7 the radial extension of the second oblique surface 47 can be smaller, since the first oblique surface 31 already has a supporting effect in the axial projection.

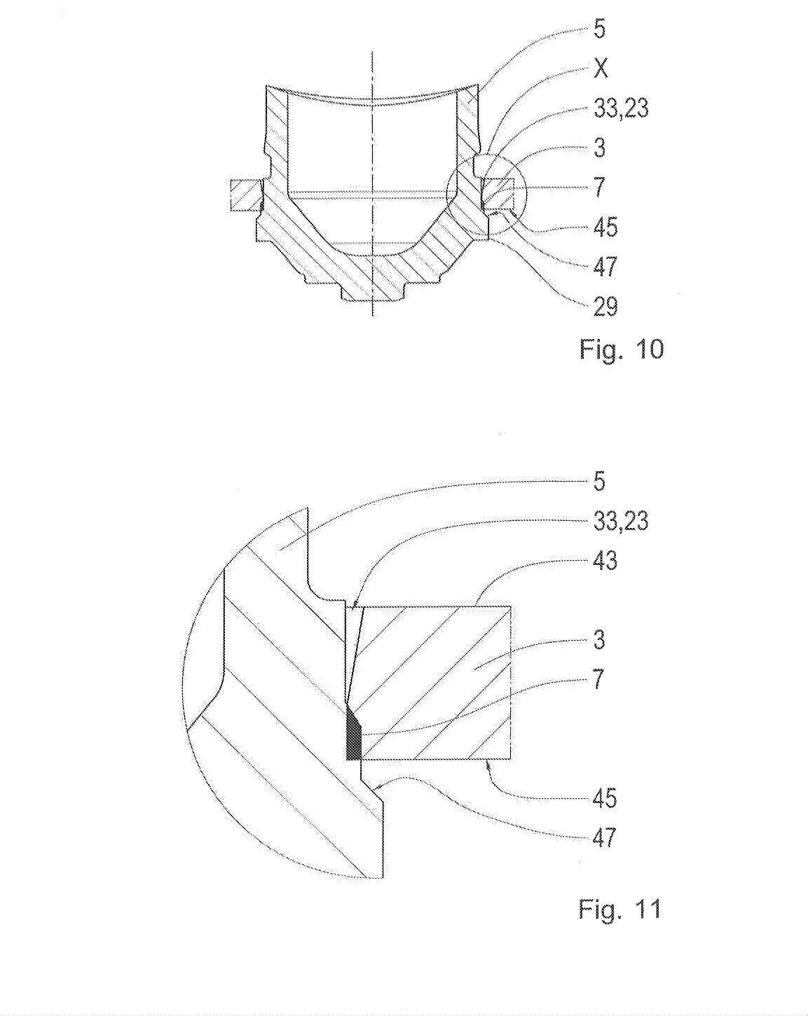

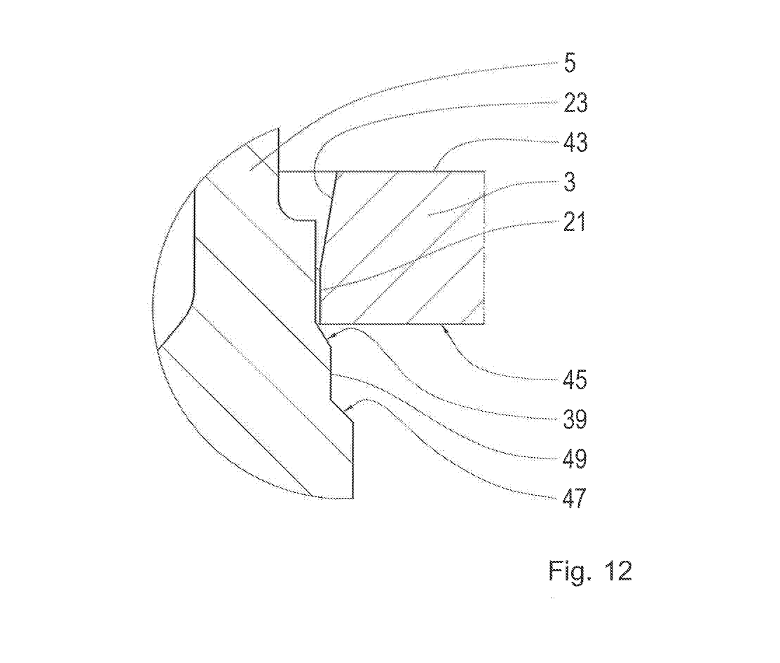

FIGS. 10 to 12 show an embodiment in which the receiving opening 19 of the structural component 3 is divided into a smooth section 21 and a stamping break-out 23, and the housing 5 again has a centering bevel 39 facing toward the receiving opening 19. For the sake of clarity, the detail marked X in FIG. 10 is shown enlarged in FIG. 11. FIG. 12 shows the same detail, but immediately before welding. The largest diameter of the centering bevel 39 is larger than the inside diameter of the receiving opening 19, so that there is an overlap between the joint partners 3; 5. Immediately before welding there is again along the centering bevel 39 a line contact between the two joint partners 3; 5. After the beginning of welding, in the axial direction the centering bevel 39 is first covered. Following on from the centering bevel 39 where its diameter is largest, in the axial extension of the housing 5 there is an area with a cylindrical outer surface 49.

Thereafter the joint partners 3; 5 are moved farther relative to one another, forming a weld 7 which, viewed in section, extends in the axial direction and is of rectangular shape. The rectangular weld 7, with sides that extend parallel to the central axis of the structural component 3 and the housing 5, extends over part of the material thickness of the structural component 3. Over the remainder of the material thickness the structural component 3 and the housing 5 are again apart from one another with an annular gap 33 between them. The weld 7 connects the smooth section 21 of the receiving opening 19 to the housing 5. The annular gap 33 is delimited by the housing 5 and the stamping break-out. In this arrangement the annular gap 33 widens out toward its open side. After the end of the welding process the structural component 3 is fixed to the housing 5 in such manner that with its underside 45 it is a distance away from the second oblique surface 47. The underside 45 and the second oblique surface 47 are at an angle of 45° to one another. The second oblique surface 47 is formed on the step 29.

### INDEXES

1 Chassis component
3 Structural component
5 Housing
7 Weld
9 Ball socket
11 Joint ball
13 Ball pin
15 Rim
17 Seal
19 Receiving opening, through-going opening
21 Smooth section
23 Stamping break-out
25 Base area
27 Housing geometry, annular wall
29 Step
31 Oblique surface
33 Annular gap
35 Rim
37 Annular groove
39 Centering bevel
41 Recess, chamfer
43 Upper side
45 Underside
47 Second oblique surface
49 Cylindrical outer surface

1-14. (canceled)

15. A method of producing a chassis component (1), having a housing (5) which is connected to a structural component (3) by a weld (7), the method comprising:
forming a receiving opening (19) in the structural component (3) and pushed the housing (5) into the receiving opening (19) such that a first surface on the housing and a second surface on the structural component are in contact with each other; and
forming at least one of the first and the second surfaces, which are in contact with each other, as an oblique surface (41; 31; 47) relative to the other of the first and the second surfaces, such that before welding, a line contact exists between the first and the second surfaces.

16. The method of producing a chassis component according to claim 15, further comprising making the receiving opening (19) in the structural component (3) slightly undersize relative to a housing geometry that is pushed into the receiving opening (19).

17. The method of producing a chassis component according to claim 15, further comprising making the housing geometry (27) so as to have either a constant cross-section or a conical cross-section.

18. The method of producing a chassis component according to claim 15, further comprising making the receiving opening (19), in the structural component (3), by a stamping process.

19. The method of producing a chassis component according to claim 18, further comprising making the receiving opening to be shaped with a recession (41) which extends obliquely to a central axis of the receiving opening (19).

20. The method of producing a chassis component according to claim 15, further comprising forming the oblique surface (31; 47) facing toward the structural component (3) on the housing (5).

21. The method of producing a chassis component according to claim 20, further comprising forming the oblique surface (47) on the housing on a step (29).

22. The method of producing a chassis component according to claim 15, further comprising making a connection of the through-going opening (19) to the housing (5) with a clearance fit such that there is an annular gap (33) therebetween.

23. The method of producing a chassis component according to claim 22, further comprising closing the annular gap (33) between the housing (5) and the through-going opening (19) by displacement of volume fractions of at least one of the housing (5) and the structural component (3).

24. The method of producing a chassis component according to claim 23, further comprising compressing a rim of the through-going opening axially.

25. The method of producing a chassis component according to claim 22, further comprising closing the annular gap (33), between the housing (5) and the through-going opening (19), by coating a welded assembly (3; 5) formed by the housing and the structural component.

26. The method of producing a chassis component according to claim 15, further comprising welding to one another outer surfaces (21; 49) of the receiving opening (19) and the housing (5) that extend, in each case, parallel to a central axes of the receiving opening (19) and the housing (5).

27. A chassis component (1) comprising a structural component (3) and a ball joint housing (5),
the housing (5) being connected to the structural component (3) by a weld (7),
a receiving opening (19) being formed in the structural component (3) and the housing (5) being pushed into the receiving opening (19) such that a first surface, on the housing, and a second surface, on the structural component, being in contact with one another,
at least one of the first and the second surfaces being an oblique surface (41; 31; 47) relative to the other of the first and the second surfaces such that, before welding, a line contact exists between the first and the second surfaces, and
the chassis component (1) being designed as either a flange joint or a multi-point link.

28. The chassis component (1) according to claim 27, wherein the ball joint housing (5) is part of one of a radial ball joint, an axial ball joint and a ball sleeve joint.

29. A method of producing a chassis component, the method comprising:
forming a receiving opening in a structural component;
pushing a ball joint housing into the receiving opening such that a first surface on the ball joint housing contacts a second surface on the structural component;
forming one of the first surface and the second surface as an oblique surface with respect to the other of the first second and the first surface such that when pushed into contact with one another, a line contact is established therebetween; and
welding the ball joint housing to the structural component at the line of contact between the first and the second surfaces.
